(19) United States
(12) Patent Application Publication
(10) Pub. No.: US 2013/0163945 A1
(43) Pub. Date: Jun. 27, 2013

(54) VIDEO SIGNAL OUTPUT METHOD AND VIDEO INFORMATION PLAYER DEVICE

(71) Applicant: Tomoaki Ryu, Tokyo (JP)

(72) Inventor: Tomoaki Ryu, Tokyo (JP)

(73) Assignee: MITSUBISHI ELECTRIC CORPORATION, Tokyo (JP)

(21) Appl. No.: 13/820,956

(22) PCT Filed: Nov. 16, 2011
(86) PCT No.: PCT/JP2011/076406

§ 371 Date: Mar. 5, 2013

(30) Foreign Application Priority Data
Nov. 22, 2010 (JP) 2010-260403

(51) Int. Cl. H04N 5/06

(52) U.S. Cl. CPC H04N 5/06
USPC 386/219

(57) ABSTRACT

A video information player device (100) comprises: a video decoder (126) which decodes content data of content and generates a video signal and a vertical synchronization signal; a synchronization frame processing unit (128) which detects the vertical synchronization signal and generates a synchronization frame triggered by the detection of the vertical synchronization signal; an Ethernet controller (121) which transmits the synchronization frame to another video information player device; and a synchronized output unit (127) which outputs the video signal in synchronization with the vertical synchronization signal. If the Ethernet controller (121) is generating an Ethernet frame when the vertical synchronization signal is detected, the synchronization frame processing unit (128) generates the synchronization frame in parallel with the generation of the Ethernet frame.

### TECHNICAL FIELD

The present invention relates to video signal output methods and video information player devices, more particularly to video signal output methods and video information player devices that output synchronized video content signals.

### BACKGROUND ART

When a screen is displayed by use of a plurality of display devices, the general method of synchronizing the screens displayed by the display devices is to output the screens to the display devices in synchronization from one player device (see, for example, Patent Reference 1).

When a 3840×2160-pixel display screen is displayed by use of four display devices having 1920×1080-pixel display screens, for example, the player device divides the image originally created with 3840×2160 pixels into four 1920×1080-pixel video pictures and outputs them to the four display devices to obtain a synchronized display.

### PRIOR ART REFERENCES

### Patent References

Patent Reference 1: Japanese patent application publication No. 2003-153128

### SUMMARY OF THE INVENTION

### Problems to be Solved by the Invention

When a plurality of screens are linked together to display single content in a digital signage application, if the display timings of the individual screens do not match, the display is of poor quality.

Video content is generally transmitted in an MPEG-2 or H.264 compressed form and stored in a storage device. The player device plays the video signal by decoding the stored data in the storage device. Decoding, for example, the above 3840×2160-pixel video picture requires a high-performance CPU, and dividing a 3840×2160-pixel video picture into four 1920×1080-pixel video pictures and outputting them to four display devices requires a high-performance graphics card. High-performance CPUs and graphics cards are generally expensive, and display systems including these high-performance CPUs and graphics cards are very expensive.

The number of screens that can be output from the graphics cards ordinarily mounted in personal computers is two; video output of four screens or more (several tens of screens) is not possible. When ordinary personal computers are employed as player devices for use in digital signage, the general method is therefore to allocate one player device to each display device and play pre-divided content on each player device. To align the display timings of the display devices, it then becomes necessary to exchange display timing information between the player devices, and provide dedicated synchronization cabling between the player devices.

When the player devices used in digital signage are deployed over a wide area however, it is frequently infeasible to hook up dedicated cables for synchronization. When dedicated synchronization cabling is infeasible, the display screens displayed on the display devices cannot be synchronized, and a poor-quality display is the result.

The present invention therefore addresses the above problem with the object of achieving synchronization without using dedicated synchronization cables, when a plurality of video information player devices output video content signals in synchronization.

### Means for Solving the Problem

According to one aspect of the invention, a video signal output method for synchronized output of video content signals by a plurality of video information player devices connected to a network comprises:

a first decoding step in which one video information player device included in the plurality of video information player devices decodes content data of the content and generates a video signal and a vertical synchronization signal;

a synchronization frame generation step in which the one video information player device detects the vertical synchronization signal and, with detection of the vertical synchronization signal as a trigger, generates a synchronization frame, the synchronization frame being an Ethernet frame including information by which the synchronization frame can be recognized as having been created with the vertical synchronization signal as the trigger; and

a synchronization frame transmission step in which the one video information player device transmits the synchronization frame to the other video information player devices included in the plurality of video information player devices over the network; wherein

if another Ethernet frame is being prepared for transmission in the one video information player device when the vertical synchronization signal is detected in the synchronization frame generation step,

the synchronization frame transmission step includes

a step of storing an Ethernet frame subsequent to the another Ethernet frame,

a step of transmitting the synchronization frame after transmission of the another Ethernet frame is completed, and

a step of transmitting the stored Ethernet frame after transmission of the synchronization frame is completed.

### Effects of the Invention

According to one aspect of the invention, when a plurality of video information player devices output video content signals in synchronization, synchronization is achieved without the use of dedicated synchronization cables.

### BRIEF DESCRIPTION OF THE DRAWINGS

FIG. 1 is a block diagram schematically showing an example of the configuration of a video information player device according to a first embodiment.

FIG. 2 is a block diagram schematically showing an example of the configuration of a video information playing system including the video information player device according to the first embodiment.

FIG. 3 is a block diagram showing the detailed configuration of the Ethernet controller and synchronization frame processing unit in the first embodiment.

FIG. 4 is a schematic diagram showing the structure of an Ethernet frame in the first embodiment.

FIG. 5 is a block diagram showing the detailed configuration of the Ethernet controller and synchronization signal processing unit in the first embodiment.

FIG. 6 is a schematic diagram showing how video pictures displayed by external display devices connected to the video information player devices in the first embodiment are combined.

FIG. 7 is a flowchart illustrating processing in the video information player device that is the reference device in the first embodiment.

FIG. 8 is a flowchart illustrating processing in the video information player devices that are non-reference devices in the first embodiment.

FIG. 9 is a block diagram schematically showing an example of the configuration of a video information player device according to a second embodiment.

FIG. 10 is a block diagram showing the detailed configuration of the Ethernet controller and synchronization frame processing unit in the second embodiment.

FIG. 11 is a timing diagram schematically showing the input or output timing of Ethernet frames output from the MAC unit, the V-SYNC signal output from the video decoder, Ethernet frames input to the FIFO memory, the synchronization frame output from the synchronization frame generating circuit, Ethernet frames output from the FIFO memory, and Ethernet frames output from the second switch in the second embodiment.

FIG. 12 is a block diagram schematically showing an example of the configuration of a video information player device according to a third embodiment.

FIG. 13 is a block diagram showing the detailed configuration of the Ethernet controller and synchronization signal processing unit in the third embodiment.

FIG. 14 is a timing diagram schematically showing the synchronization frame reception timing, the output timing of the V-SYNC signal from the vertical synchronization signal generating circuit, the mask signal occurrence timing in the interpolative vertical synchronization signal generating circuit, the output timing of the V-SYNC signal from the interpolative vertical synchronization signal generating circuit, and the output timing of the V-SYNC signal from the synchronization signal processing unit in the third embodiment.

### MODE FOR CARRYING OUT THE INVENTION

### First Embodiment

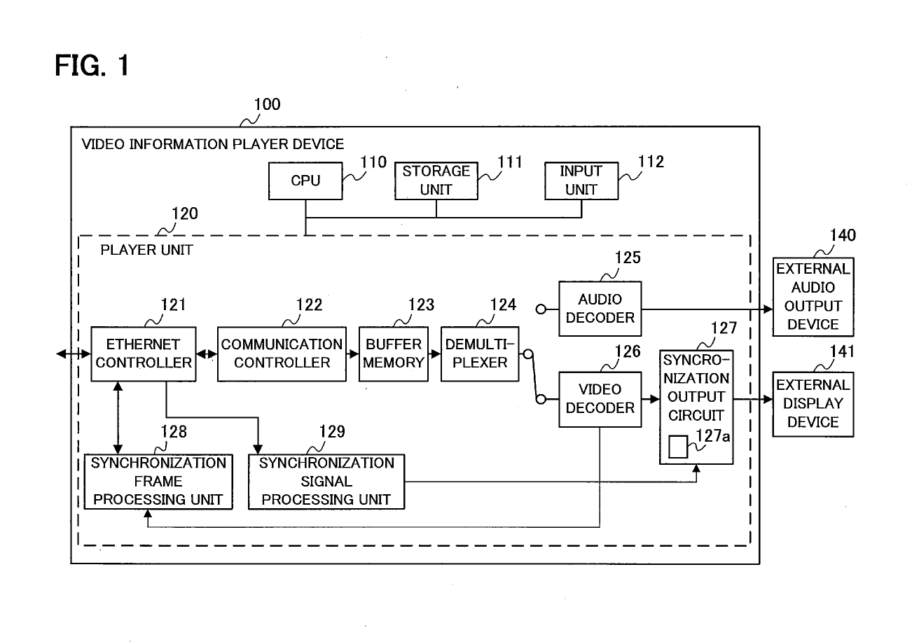

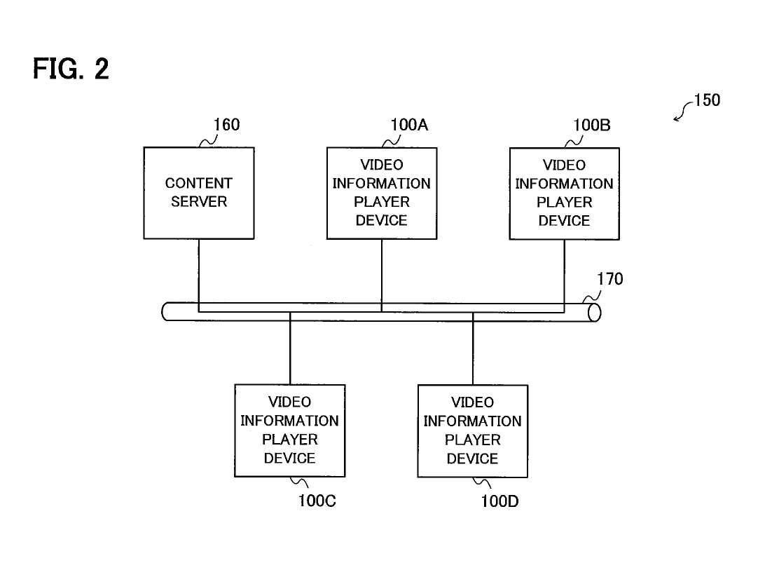

FIG. 1 is a block diagram schematically showing an example of the configuration of a video information player device 100 according to the first embodiment. FIG. 2 is a block diagram schematically showing an example of the configuration of a video information playing system 150 including the video information player device 100. As shown in FIG. 2, the video information playing system 150 has a plurality of video information player devices 100A-100D (referred to as video information player devices 100 when there is no particular need to distinguish among them) and a content server 160; the video information player devices 100 and content server 160 are connected to an Ethernet network 170, Ethernet being a commonly used protocol (and a registered trademark). The content server 160 distributes content data by, for example, unicast transmission using UDP (User Datagram Protocol); the video information player devices 100 receive the content data from the content server 160 via the network 170 and play audio and video based on the content data. One of the plurality of video information player devices 100A-100D here is a synchronization reference (referred to below as the reference device). The devices other than the reference device among the plurality of video information player devices 100A-100D (referred to below as non-reference devices) output video signals in synchronization with the reference device.

As shown in FIG. 1, the video information player device 100 has a CPU 110 functioning as a control unit, a storage unit 111, an input unit 112, and a player unit 120.

The CPU 110 executes overall control of the video information player device 100. The CPU 110, for example, receives an input as to whether the video information player device 100 is the reference device or a non-reference device through the input unit 112, generates synchronization reference setting information that indicates whether the video information player device 100 is the reference device or a non-reference device based on the input, and carries out processing for storing the synchronization reference setting information in the storage unit 111. Alternatively, the CPU 110 may receive an input like this from the network 170 through the player unit 120. The CPU 110 controls the player unit 120 to have the player unit 120 receive content data from the content server 160 and play audio and video based on the content data.

The storage unit 111 stores information required for processing in the video information player device 100. For example, the storage unit 111 stores the synchronization reference setting information that distinguishes whether the video information player device 100 itself is the reference device or a non-reference device.

The input unit 112 receives input due to manual operations. In the first embodiment, for example, it receives an input indicating whether the video information player device 100 is the reference device or a non-reference device.

The player unit 120, functioning as a player means, plays audio and video based on content data distributed from the content server 160. Processing in the player unit 120 is controlled by the CPU 110.

The player unit 120 has an Ethernet controller 121, a communication controller 122, a buffer memory 123, a demultiplexer 124, an audio decoder 125, a video decoder 126, a synchronization output circuit 127 functioning as a synchronization output unit, a synchronization frame processing unit 128, and a synchronization signal processing unit 129.

The Ethernet controller 121 transmits and receives signals via the network 170. For example, the Ethernet controller 121 receives signals from the network 170, generates IP packets based on the signals, and supplies the generated IP packets to the communication controller 122. The Ethernet controller 121 also generates signals based on Ethernet frames supplied from the synchronization frame processing unit 128, and outputs the generated signals to the network 170. Moreover, the Ethernet controller 121 generates Ethernet frames based on IP packets supplied from the communication controller 122, and signals based on the generated Ethernet frames, and outputs the generated signals to the network 170.

The communication controller 122 carries out processing for generating TS packets based on IP packets supplied from the Ethernet controller 121 and storing the generated TS packets in the buffer memory 123. When the information stored in an IP packet supplied from the Ethernet controller 121 is not a TS packet, the communication controller 122 supplies the information to the CPU 110. The communication controller 122 also generates IP packets based on information supplied from the CPU 110, and supplies the generated IP packets to the Ethernet controller 121.

The buffer memory 123 temporarily stores the TS packets supplied from the communication controller 122.

The demultiplexer 124 reads the TS packets from the buffer memory 123, and demultiplexes the TS packets into data such as video data and audio data. The demultiplexer 124 sends the demultiplexed audio data to the audio decoder 125, and sends the demultiplexed video data to the video decoder 126.

The audio decoder 125 generates an audio signal by decoding the audio data sent from the demultiplexer 124, and outputs the generated audio signal to an external audio output device 140 such as a speaker.

The video decoder 126 generates a video signal, a V-SYNC signal (vertical synchronization signal), an H-SYNC signal (horizontal synchronization signal), and a video data clock by decoding the video data sent from the demultiplexer 124, and supplies the generated signals to the synchronization output circuit 127, and supplies the V-SYNC signal to the synchronization frame processing unit 128.

When the video information player device 100 having the synchronization output circuit 127 itself is the reference device, the synchronization output circuit 127 outputs the video signal supplied from the video decoder 126 to an external display device 141 in synchronization with the V-SYNC signal supplied from the video decoder 126. When the video information player device 100 having the synchronization output circuit 127 itself is a non-reference device, the synchronization output circuit 127 outputs the video signal supplied from the video decoder 126 to the external display device 141 in synchronization with the V-SYNC signal supplied from the synchronization signal processing unit 129.

In the first embodiment, the synchronization output circuit 127 has a frame memory 127a, stores the video signal supplied from the video decoder 126 in the frame memory 127a, and outputs the stored video signal in synchronization with the V-SYNC signal. The frame memory 127a has, for example, a first frame memory and a second frame memory (not shown). The synchronization output circuit 127 stores the video data for the first frame in the first frame memory, and outputs the video data for the first frame stored in the first frame memory in synchronization with the V-SYNC signal. When decoding of the video data for the second frame by the video decoder 126 is completed, the video data for the second frame are stored in the second frame memory in the synchronization output circuit 127. The video data for the second frame stored in the second frame memory are output in synchronization with the next input V-SYNC signal. The decoded data for the third frame are stored in the first frame memory, from which the output of the video data for the first frame has already been completed. The subsequent frames of data decoded by the video decoder 126 are also output sequentially in synchronization with the V-SYNC signal.

When triggered by a V-SYNC signal supplied from the video decoder 126, the synchronization frame processing unit 128 generates a synchronization frame, which is an Ethernet frame including information by which the synchronization frame can be recognized as having been created with the V-SYNC signal as the trigger, and supplies the generated synchronization frame to the Ethernet controller 121.

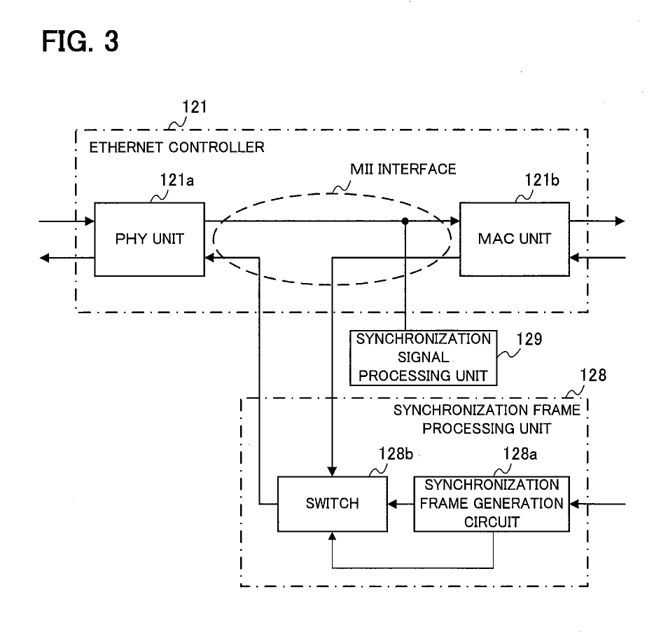

FIG. 3 is a block diagram showing the detailed configuration of the Ethernet controller 121 and synchronization frame processing unit 128.

The Ethernet controller 121 has a PHY unit 121a that handles physical signals and a MAC unit 121b that handles logic signals. The PHY unit 121a and the MAC unit 121b are linked by an MII (Media Independent Interface), which is common in 100BASE-T.

The synchronization frame processing unit 128 has a synchronization frame generating circuit 128a functioning as a synchronization frame generating unit, and a switch 128b functioning as a switching unit.

When the V-SYNC signal is supplied from the video decoder 126, the supplied V-SYNC signal triggers the synchronization frame generating circuit 128a to generate a synchronization frame.

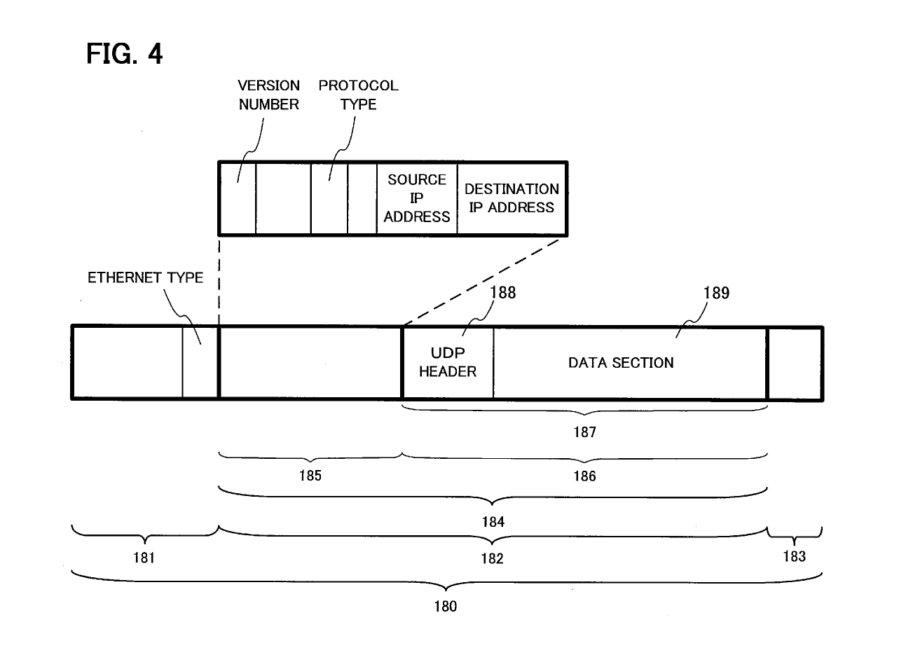

FIG. 4 is a schematic diagram showing the structure of an Ethernet frame 180. The Ethernet frame 180 has an Ethernet header 181, frame data 182, and an FCS (Frame Check Sequence) 183. The Ethernet header 181 includes a destination MAC address, a source MAC address, and an Ethernet type field. An IP packet 184 is stored in the frame data 182. Data for detecting errors in the Ethernet frame 180 are stored in the FCS 183.

The IP packet 184 has an IP header 185 and an IP payload 186. A version number, a protocol type, a source IP address, a destination IP address, and other information are stored in the IP header 185. In the first embodiment, when synchronization frames are generated, the value “0100” representing Internet Protocol Version 4 is set as the version number. The value “0110” representing Internet Protocol Version 6, however, may be set instead. The value “00010001” representing the User Datagram Protocol (UDP) is set as the protocol type. An arbitrary multicast address from “244.0.0.0” to “239.255.255.255” is set as the destination IP address. As other header information, any values conforming to the IP header standard may be set; these values are not designated in the first embodiment.

A UDP socket 187 is stored in the IP payload 186 in the IP packet 184. The UDP socket 187 has a UDP header 188 and a data section 189.

In the data section 189 in the Ethernet frame 180 configured as described above, the synchronization frame generating circuit 128a inserts a unique 13-byte data string by which the synchronization frame can be recognized as having been created with the V-SYNC signal output from the video decoder 126 as the trigger. In the first embodiment, for example, the hexadecimal numbers “56, 2D, 53, 59, 4E, 43, 20, 48, 45, 41, 44, 45, 52” are assigned to the data string. In the ASCII code, this data string converts to “V-SYNC HEADER”. The data to be inserted in the data section in the synchronization frame are not restricted to the data string described above, but may be any data by which the synchronization frame can be recognized as having been created with the V-SYNC signal as the trigger, and there is no particular restriction on the data size.

The synchronization frame generating circuit 128a generates the UDP socket 187 by inserting the data string described above in the data section 189 and adding the UDP header 188, and generates the IP packet 184 by inserting the generated UDP socket 187 in the IP payload 186 and adding the IP header 185. Moreover, the synchronization frame generating circuit 128a generates the Ethernet frame 180 of the synchronization frame by inserting the IP packet 184 generated as described above in the frame data 182 and adding the Ethernet header 181 and FCS 183.

The synchronization frame generating circuit 128a supplies the synchronization frame generated as described above to the switch 128b.

Returning to FIG. 3, the switch 128b switchably outputs to the PHY unit 121a either the Ethernet frame output from the MAC unit 121b and a TX_EN (Transmit Enable) signal indicating switching to the Ethernet frame, or the synchronization frame output from the synchronization frame generating circuit 128a and a TX_EN signal indicating switching to the synchronization frame.

When, for example, a synchronization frame is received from the synchronization frame generating circuit 128a, the switch 128b selects the input from the synchronization frame generating circuit 128a and outputs the synchronization frame and the TX_EN signal to the PHY unit 121a. The switch 128b selects the input from the synchronization frame generating circuit 128a for the duration of input of the synchronization frame and TX_EN signal from the synchronization frame generating circuit 128a. When input of the synchronization frame is completed, the switch 128b switches back to input from the MAC unit 121b.

Returning to FIG. 1, when the Ethernet controller 121 receives synchronization frame data from the reference device, the synchronization signal processing unit 129 generates a V-SYNC signal and outputs the V-SYNC signal to the synchronization output circuit 127.

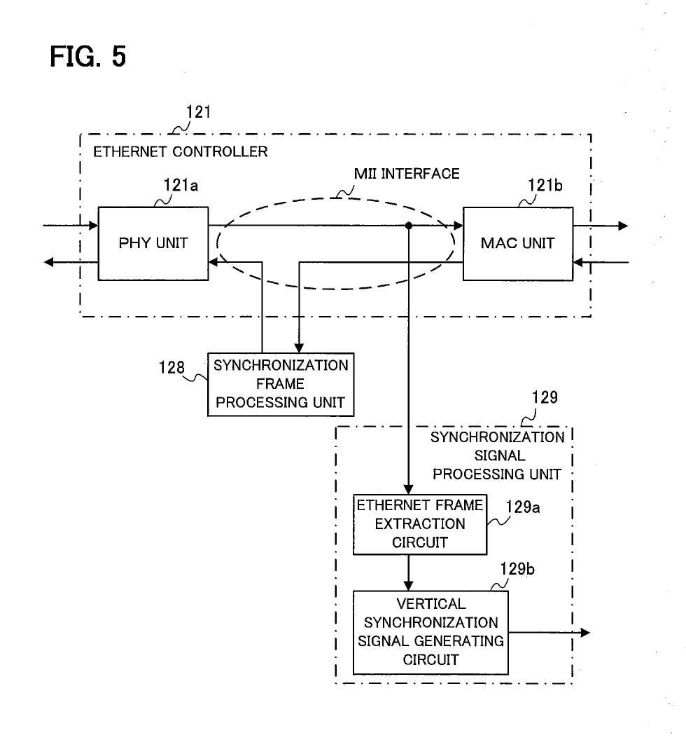

FIG. 5 is a block diagram showing the detailed configuration of the Ethernet controller 121 and synchronization signal processing unit 129.

The synchronization signal processing unit 129 has an Ethernet frame extraction circuit 129a functioning as an Ethernet frame extraction unit, and a vertical synchronization signal generating circuit 129b functioning as a vertical synchronization signal generating unit.

The Ethernet frame extraction circuit 129a monitors the Ethernet frames sent from the PHY unit 121a to the MAC unit 121b, extracts data inserted in the data section in the UDP socket from an Ethernet frame when it decides that there is a strong possibility that the Ethernet frame is a synchronization frame, and supplies the extracted data to the vertical synchronization signal generating circuit 129b. For example, the Ethernet frame extraction circuit 129a monitors the information inserted in the IP header in the Ethernet frame, and decides that there is a strong possibility that the Ethernet frame is a synchronization frame when the protocol type value inserted in the IP header is “00010001”, indicating UDP, and the destination IP address stored in the IP header is any address from “244.0.0.0” to “239.255.255.255”, indicating a multicast address.

The vertical synchronization signal generating circuit 129b decides whether or not the data supplied from the Ethernet frame extraction circuit 129a are information by which the synchronization frame can be recognized as having been created with a V-SYNC signal as the trigger. The vertical synchronization signal generating circuit 129b, for example, checks whether or not the initial part of the data supplied from the Ethernet frame extraction circuit 129a matches hexadecimal “56, 2D, 53, 59, 4E, 43, 20, 48, 45, 41, 44, 45, 52”. When a match is confirmed, the Ethernet frame extraction circuit 129a decides that the data are information by which the synchronization frame can be recognized as having been created with a V-SYNC signal as the trigger, and supplies a V-SYNC signal to the synchronization output circuit 127.

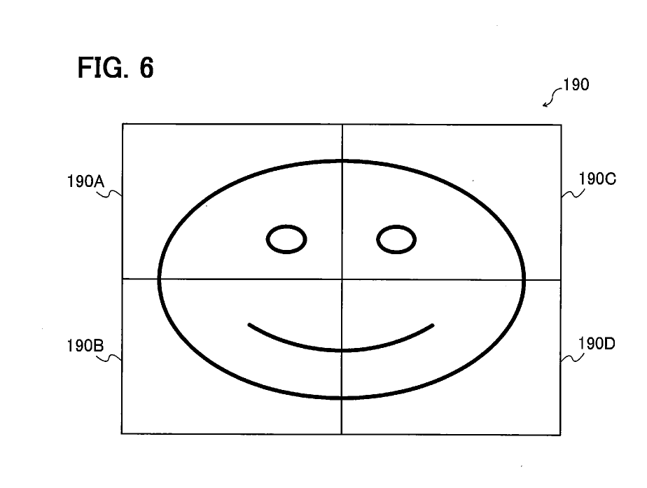

The content server 160 shown in FIG. 2 distributes content data to each of the video information player devices 100A-100D via the network 170. In the first embodiment, a single video picture is formed by combining screens displayed by external display devices 141 connected to each of the video information player devices 100A-100D. FIG. 6 is an exemplary schematic diagram showing how video pictures displayed by external display devices 141 connected to the video information player devices 100A-100D are combined. The video picture 190 shown in FIG. 6 includes video pictures 190A-190D. Video picture 190A is the image displayed on the external display device 141 connected to the video information player device 100A; video picture 190B is the image displayed on the external display device 141 connected to the video information player device 100B; video picture 190C is the image displayed on the external display device 141 connected to the video information player device 100C; video picture 190D is the image displayed on the external display device 141 connected to the video information player device 100D. Although the video information player devices 100A-100D that display the video pictures 190A-190D are connected to separate external display devices 141, a single video picture 190 is formed by combining the four video pictures 190A-190D. The content server 160 therefore generates separate content data for the video pictures 190A-190D displayed by the external display devices 141 connected to the video information player devices 100A-100D and distributes each of the data to the respective video information player devices 100A-100D. The content server 160 adjusts the amounts of content data to be distributed to the video information player devices 100A-100D so that the buffer memories 123 in the video information player devices 100A-100D do not overflow or underflow. In the first embodiment, the content data distributed to the video information player devices 100A-100D are encoded at approximately equal bit rates, and distributed at approximately equal bit rates.

In the first embodiment, the content data distributed from the content server 160 form a TS (Transport Stream). In this case, the audio data and video data are divided into PES (Packetized Elementary Stream) packets, then further divided into TS packets, and distributed with the audio data and video data multiplexed.

A PES packet is a packet in which PES header information is added to the ES (Elementary Stream) encoded in MPEG-2 or H.264 format. PES packets are packetized in the units of time in which reproduction is controlled; for video data, for example, a single image frame (picture) is inserted in a single PES packet. The header information of the PES packet header information includes a time stamp, for example, a PTS (Presentation Time Stamp), which is information giving the time at which to reproduce the packet.

A TS packet has a fixed length (188 bytes), and a PID (Packet ID) unique to each data type is placed in the header of each TS packet. Whether the TS packet includes video data, audio data, or system information (such as reproduction control information) can be recognized by the PID. The demultiplexer 124 reads the PID, recognizes whether the TS packet includes video data or audio data, and assigns the data to the appropriate decoder.

Although content data are divided into 188-byte TS packets in the description of the first embodiment, non-TS formats may be used provided whether the content data are video data or audio data can be recognized from the data format. When data including video data without audio data are distributed, the PES (Packetized Elementary Stream) can be used as is, without being divided into TS packets. The demultiplexer 124 and the audio decoder 125 in the player unit 120 are then unnecessary.

Processing in the video information player devices 100A-100D configured as described above will be described below. In the description, it is assumed that video information player device 100A is the reference device, and video information player devices 100B-100D are non-reference devices.

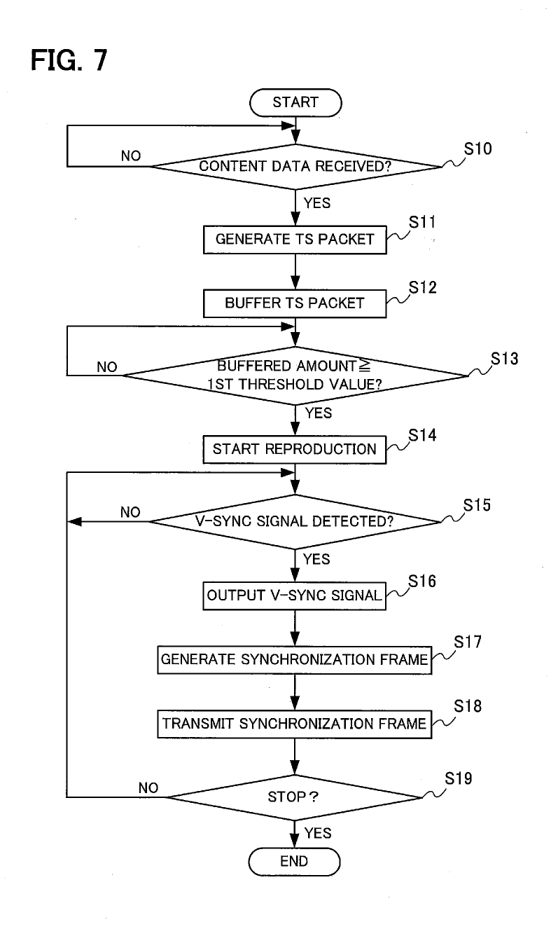

FIG. 7 is a flowchart illustrating processing in the video information player device 100A that is the reference device.

First, when the Ethernet controller 121 in the video information player device 100A receives an Ethernet frame in which content data are inserted (Yes in step S10), the Ethernet controller 121 generates an IP packet from the received Ethernet frame, and sends the generated IP packet to the communication controller 122.

Next, the communication controller 122 generates a TS packet from the IP packet sent from the Ethernet controller 121 (S11). The communication controller 122 stores the generated TS packet in the buffer memory 123 (S12).

The CPU 110 constantly monitors the (remaining) amount of data stored in the buffer memory 123, and decides whether or not the amount of data stored in the buffer memory 123 has reached an upper limit (a first threshold value) (S13). When the amount of data stored in the buffer memory 123 reaches the upper limit (Yes in step S13), the CPU 110 proceeds to step S14.

When the amount of data stored in the buffer memory 123 reaches the upper limit (Yes in step S13), the CPU 110 performs control for transmitting an instruction to halt data transmission to the content server 160 through the communication controller 122 and Ethernet controller 121. Since the content server 160 distributes equivalent amounts of data to the video information player devices 100A-100D, the amounts of data stored in the buffer memories 123 in the respective video information player devices 100A-100D at this time are approximately equal. Upon receiving the instruction, the content server 160 stops distributing content data to the video information player devices 100A-100D.

When the amount of data stored in the buffer memory 123 becomes equal to or less than a certain threshold value, the CPU 110 performs control for transmitting an instruction to resume data transmission to the content server 160 through the communication controller 122 and Ethernet controller 121. This threshold value may be equal to the first threshold value, or may be a third threshold value less than the first threshold value.

Next, the CPU 110 in the video information player device 100A instructs the player unit 120 to start video reproduction (S14). Following this instruction, TS packets are sent from the buffer memory 123 to the demultiplexer 124 in the player unit 120. The demultiplexer 124 separates the arriving TS packets into audio data and video data according to their PIDs, sends the audio data to the audio decoder 125, and sends the video data to the video decoder 126. The video decoder 126 decodes the received video data to generate a video signal, a V-SYNC signal, an H-SYNC signal, and a video data clock, all of which are output to the synchronization output circuit 127.

The synchronization output circuit 127 outputs the video signal supplied from the video decoder 126 to the external display device 141 in synchronization with the V-SYNC signal supplied from the video decoder 126. Alternatively, the synchronization output circuit 127 may delay the video signal for a predetermined time and output the delayed video signal to the external display device 141. The delay time may be preset in consideration of the times at which the V-SYNC signal is transmitted to video information player devices 100B-100D.

The video decoder 126 detects whether or not the V-SYNC signal has been generated (S15). When the V-SYNC signal is generated (Yes in step S15), the video decoder 126 sends the generated V-SYNC signal to the synchronization frame processing unit 128 (S16).

When the synchronization frame processing unit 128 receives the V-SYNC signal, the synchronization frame generating circuit 128a generates a synchronization frame (S17). The generated synchronization frame is sent to the switch 128b; the synchronization frame processing unit 128 receives the synchronization frame and sends it to the PHY unit 121a.

Upon receiving the synchronization frame, the PHY unit 121a performs physical layer processing, generates an electrical signal based on the received synchronization frame, and transmits the generated electrical signal to the network 170 (S18).

The CPU 110 now decides whether or not to stop reproducing content (S19). If it decides to stop reproducing content (Yes in step S19), it outputs an instruction to the player unit 120 to terminate reproduction and the process ends. If it decides not to stop reproduction (No in step S19), it returns to the processing in step S15.

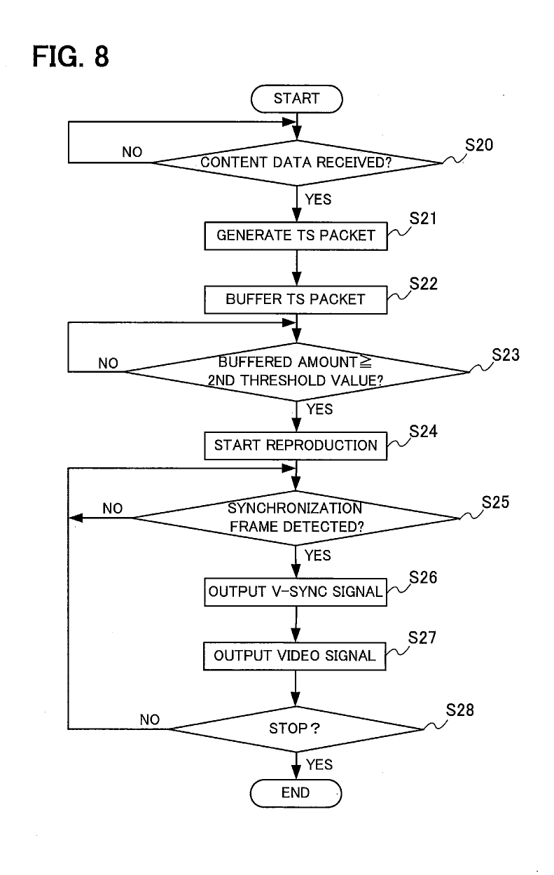

FIG. 8 is a flowchart illustrating processing in the video information player devices 100B-100D that are non-reference devices.

First, when the Ethernet controllers 121 in video information player devices 100B-100D receive Ethernet frames in which content data are inserted (Yes in step S20), the Ethernet controllers 121 generate IP packets from the received Ethernet frames, and send the generated IP packets to the communication controllers 122.

Next, the communication controllers 122 generate TS packets from the IP packets sent from the Ethernet controllers 121 (S21). The communication controllers 122 store the generated TS packets in the buffer memories 123 (S22).

The CPUs 110 constantly monitor the amounts of data in the buffer memories 123, and decide whether or not the amounts of data in the buffer memories 123 have reached an upper limit (a second threshold value) (S23). When the amount of data stored in a buffer memory 123 reaches the upper limit (Yes in step S23), the relevant CPU 110 proceeds to step S24.

Although the second threshold value may be equal to the first threshold value, it is preferably less than the first threshold value. The difference between the second threshold value and the first threshold value may be preferably decided based on the communication speed of content data from the content server 160, for example, such that the length of time between the start of decoding in the non-reference video information player devices 100B-100D and the start of decoding in the reference video information player device 100A is longer than the length of time between detection of the V-SYNC signal in video information player device 100A (in step S15 in FIG. 7) and reception by the synchronization output circuits 127 in video information player devices 100B-100D of the V-SYNC signals from the synchronization signal processing units 129. In terms of data size, the difference between the second threshold value and the first threshold value may be large enough to include at least one frame of data. On the assumption that, for example, the bit rate of the data distributed from the content server 160 is 10 Mbps, the second threshold value may set at a value approximately 2 Mbits lower than the first threshold value. Making the second threshold value less than the first threshold value as described above ensures that decoding of the video data will have been completed by the time the synchronization output circuits 127 in video information player devices 100B-100D receive the V-SYNC signal from the synchronization signal processing units 129.

Next, the CPUs 110 in video information player devices 100B-100D instruct the player units 120 to start video reproduction (S24). Following this instruction, TS packets are sent from the buffer memories 123 to the demultiplexers 124 in the player units 120. The demultiplexers 124 separate audio data and video data from the arriving TS packets according to their PIDs, send the audio data to the audio decoders 125, and send the video data to the video decoders 126. The video decoders 126 decode the video data that they receive to generate video signals, V-SYNC signals, H-SYNC signals, and video data clocks, all of which are output to the synchronization output circuits 127. The CPUs 110 then monitor the video decoders 126. Upon confirming that decoding of data for a single frame is completed, a CPU 110 temporarily discontinues the decoding processing in the relevant video decoder 126. The video signals each of which has data for a single frame sent to the synchronization output circuits 127 are stored in the frame memories 127a in the synchronization output circuits 127.

Next, when the Ethernet frame extraction circuits 129a and vertical synchronization signal generating circuits 129b in the synchronization signal processing units 129 detect a synchronization frame (Yes in step S25), the vertical synchronization signal generating circuits 129b output V-SYNC signals to the synchronization output circuits 127 (S26).

Upon receiving the V-SYNC signals, the synchronization output circuits 127 output the video signals stored in the frame memories 127a to the external display devices 141 in synchronization with the V-SYNC signals received from the vertical synchronization signal generating circuits 129b (S27).

The output of the V-SYNC signals from the synchronization signal processing units 129 triggers the CPUs 110 to resume the decoding operation in the video decoders 126. The CPUs 110 then monitor the video decoders 126. Upon recognizing that decoding of data for a single frame is completed, a CPU 110 temporarily discontinues the decoding processing in the relevant video decoder 126.

The CPUs 110 now decide whether or not to stop reproducing content (S28). If they decide to stop reproducing content (Yes in step S28), they output instructions to the player units 120 to terminate reproduction and the process ends. If they decide not to stop reproduction (No in step S28), they return to the processing in step S25.

Next, the delay between the occurrence of a V-SYNC signal in the reference video information player device 100A and the output of V-SYNC signals from the synchronization signal processing units 129 in the non-reference video information player devices 100B-100D devices will be described.

Assuming that the size of a synchronization frame is the 64-byte minimum size specified in the standard, since 100-Mbit-per-second data transmission is possible in 100BASE-T, approximately 5 μsec are required for 64-byte data transmission. Assuming an approximately 5-μsec delay in the hub and assuming that the synchronization signal processing units 129 in video information player devices 100B-100D take approximately 5 μsec to detect whether or not an Ethernet frame is a synchronization frame, there is a delay of approximately 15 μsec between the occurrence of a V-SYNC signal in the video information player device 100A and the output of V-SYNC signals from the synchronization signal processing units 129 in video information player devices 100B-100D. At 30 frames/sec, the period of the V-SYNC signal is approximately 33.37 msec. Because the 15-μsec delay is less than 0.045% of this period, the occurrence of the V-SYNC signal in video information player device 100A could be said to be substantially simultaneous with the occurrence of the V-SYNC signals from the synchronization signal processing units 129 in video information player devices 100B-100D.

As described above, the video information player devices 100A-100D according to the first embodiment can perform reproduction synchronization with high precision among the video information player devices 100A-100D without dedicated synchronization cables by transmission of V-SYNC signals via the network 170. Although V-SYNC signals are transmitted via the network 170 using 100BASE-T in the description in the first embodiment, if 1000BASE-T is used, V-SYNC signals can be transmitted at higher speed. The first embodiment uses unicast transmission employing UDP, but a similar effect can be obtained even if broadcast transmission or multicast transmission is used instead of unicast transmission. When only a few video information player devices 100 are connected, a similar effect can be obtained even if V-SYNC signals are transmitted by using TCP connections.

### Second Embodiment

Although a method that transmits V-SYNC signals via the network 170 was described in the first embodiment, besides the data distributed from the content server 160, various other data are transmitted over the network 170. Because the video information player devices 100 also output various data to the network 170, depending on the timing of the V-SYNC signal, a synchronization frame may be output from the synchronization frame generating circuit 128a during the output of an Ethernet frame from the MAC unit 121b, and an Ethernet frame may be output from the MAC unit 121b during the output of a synchronization frame from the synchronization frame generating circuit 128a. The synchronization frame then collides with the other Ethernet frame. In the second embodiment, even if the output of a synchronization frame from the synchronization frame generating circuit 128a coincides with the output of an Ethernet frame from the MAC unit 121b, the synchronization frame can be transmitted without a collision between these frames.

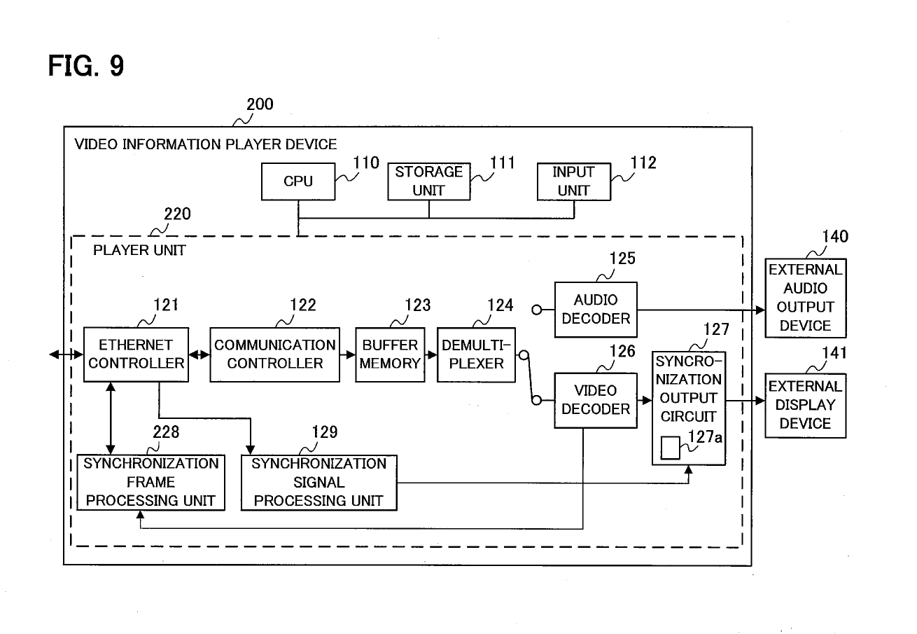

FIG. 9 is a block diagram schematically showing an example of the configuration of a video information player device 200 according to the second embodiment. The video information player device 200 has a CPU 110, a storage unit 111, an input unit 112, and a player unit 220. The video information player device 200 according to the second embodiment differs from the video information player device 100 according to the first embodiment in regard to the player unit 220.

The player unit 220 has an Ethernet controller 121, a communication controller 122, a buffer memory 123, a demultiplexer 124, an audio decoder 125, a video decoder 126, a synchronization output circuit 127, a synchronization frame processing unit 228, and a synchronization signal processing unit 129. The player unit 220 according to the second embodiment differs from the player unit 120 according to the first embodiment in regard to the synchronization frame processing unit 228.

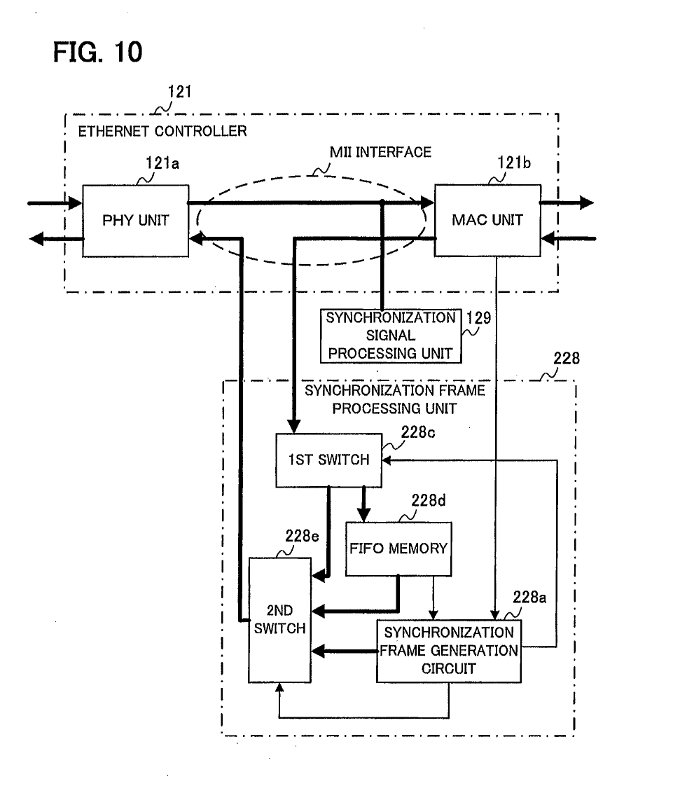

FIG. 10 is a block diagram showing the detailed configuration of the Ethernet controller 121 and synchronization frame processing unit 228. The Ethernet controller 121 is configured as in the first embodiment.

The synchronization frame processing unit 228 has a synchronization frame generating circuit 228a, a first switch 228c functioning as a first switching unit, a FIFO (First In First Out) memory 228d functioning as a storage unit, and a second switch 228e functioning as a second switching unit.

When the V-SYNC signal is supplied from the video decoder 126, the supplied V-SYNC signal triggers the synchronization frame generating circuit 228a to generate a synchronization frame. The synchronization frame generating circuit 228a controls the first switch 228c to have the first switch 228c switch output destinations and controls the second switch 228e to have the second switch 228e switch input sources. For example, if the V-SYNC signal is received when generation of an Ethernet frame is already completed in the MAC unit 121b and the Ethernet frame is being output from the first switch 228c to the second switch 228e (when the Ethernet frame is being prepared for transmission), after completion of the output of the Ethernet frame to the second switch 228e, the 228a controls the first switch 228c to have the first switch 228c switch its output destination to the FIFO memory 228d, and controls the second switch 228e to have the second switch 228e switch its input source to the synchronization frame generating circuit 228a, in order to output a synchronization frame to the PHY unit 121a. If a synchronization frame is being output to the second switch 228e (if the synchronization frame is being prepared for transmission) when an Ethernet frame is output to the first switch 228c from the MAC unit 121b (when a synchronization frame has been generated in the synchronization frame generating circuit 228a, but generation of an Ethernet frame has not yet been completed in the MAC unit 121b), the synchronization frame generating circuit 228a controls the first switch 228c to have the first switch 228c switch its output destination to the FIFO memory 228d. After completion of the output of the synchronization frame, the synchronization frame generating circuit 228a has the second switch 228e switch its input source to the FIFO memory 228d, if an Ethernet frame is stored in the FIFO memory 228d, or to the first switch 228c, if an Ethernet frame is not stored in the FIFO memory 228d.

Responding to control by the synchronization frame generating circuit 228a, the first switch 228c switches the output destinations of Ethernet frames sent from the MAC unit 121b between the second switch 228e and the FIFO memory 228d.

The FIFO memory 228d stores Ethernet frames sent from the first switch 228c.

Responding to control by the synchronization frame generating circuit 228a, the second switch 228e switches the input source of the Ethernet frames output to the PHY unit 121a to one of the synchronization frame generating circuit 228a, the first switch 228c, and the FIFO memory 228d.

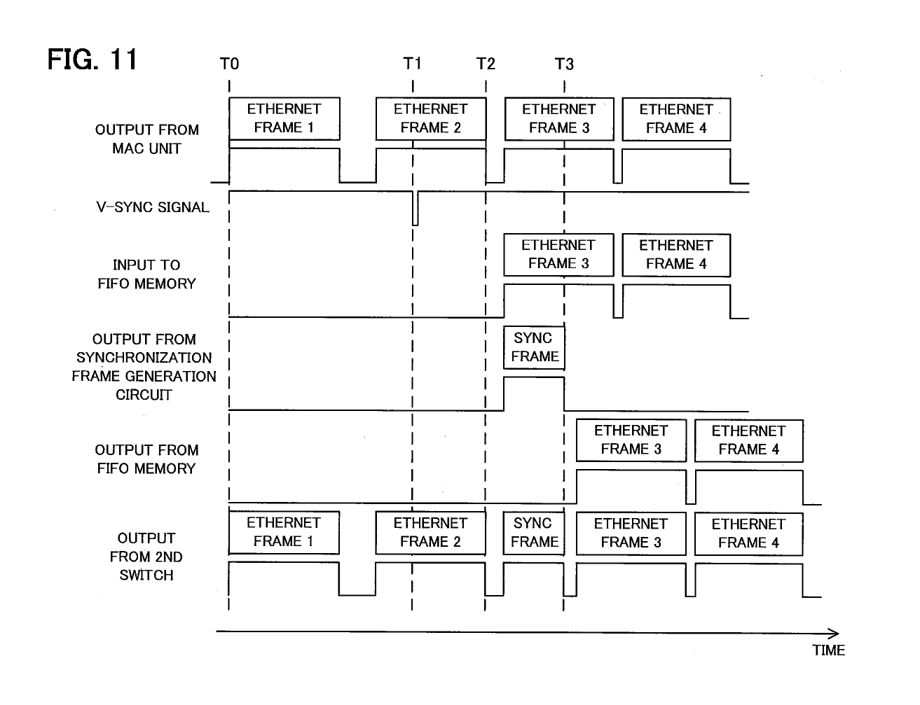

FIG. 11 is a timing diagram schematically showing the input and output timings of Ethernet frames output from the MAC unit 121b, the V-SYNC signal output from the video decoder 126, Ethernet frames input to the FIFO memory 228d, the synchronization frame output from the synchronization frame generating circuit 228a, Ethernet frames output from the FIFO memory 228d, and Ethernet frames output from the second switch 228e. In this timing diagram, four Ethernet frames are output consecutively from the MAC unit 121b.

Normally, the first switch 228c is set so as to output Ethernet frames output from the MAC unit 121b to the second switch 228e and the second switch 228e is set so as to output Ethernet frames output from the first switch 228c to the PHY unit 121a.

First, at time T0, when output of an Ethernet frame from the MAC unit 121b starts, a first Ethernet frame 1 is output to the PHY unit 121a through the first switch 228c and the second switch 228e.

At time T1, when a second Ethernet frame 2 is being output from the MAC unit 121b, a V-SYNC signal is input to the synchronization frame generating circuit 228a from the video decoder 126. The MAC unit 121b is then outputting the second Ethernet frame 2, and a synchronization frame cannot be inserted during the output of Ethernet frame 2. The synchronization frame generated in the synchronization frame generating circuit 228a is therefore not output, but held in a memory (not shown) in the synchronization frame generating circuit 228a.

The TX_EN signal is output from the MAC unit 121b to the synchronization frame generating circuit 228a, and the synchronization frame generating circuit 228a monitors the transitions from one Ethernet frame to the next. At time T2, upon detecting that output of the second Ethernet frame 2 is completed, the synchronization frame generating circuit 228a controls the first switch 228c to have the first switch 228c switch its output to the FIFO memory 228d. The synchronization frame generating circuit 228a controls the second switch 228e to have the second switch 228e switch its input source to the synchronization frame generating circuit 228a.

At time T3, when output of the synchronization frame is completed, the synchronization frame generating circuit 228a controls the second switch 228e to have the second switch 228e switch its input source to the FIFO memory 228d.

The FIFO memory 228d is structured to shift data in synchronization with a transmit clock supplied from the MAC unit 121b, and has a capacity equivalent to the data output from the MAC unit 121b during the output of the synchronization frame from time T2 to time T3. When the synchronization frame generating circuit 228a switches the input of the second switch 228e to the output of the FIFO memory 228d at time T3, an Ethernet frame 3 output from the FIFO memory 228d is output from the second switch 228e. A subsequent fourth Ethernet frame 4 also passes through the FIFO memory 228d, and is output from the second switch 228e to the PHY unit 121a. After output of the fourth Ethernet frame 4 from the MAC unit 121b is completed and a predetermined time elapses, the synchronization frame generating circuit 228a controls the first switch 228c to have the first switch 228c switch its output from the first switch 228c to the second switch 228e.

As shown in FIG. 11, when the time at which output of the second Ethernet frame 2 starts and the time at which a synchronization frame is generated are identical or approximately identical, a maximum delay of one frame (1522 bytes) may occur before the synchronization frame is output to the PHY unit 121a. In 100BASE-T, however, 1522-byte data are transmitted in approximately 120 μsec. At 30 frames/sec, this is less than 4% of the period of the V-SYNC signal and does not raise serious problems in practical applications.

As described above, by using the FIFO memory 228d to temporarily save the Ethernet frames output from the MAC unit 121b during the output of a synchronization frame, a collision between the synchronization frame and an Ethernet frame from the MAC unit 121b is avoided, and the synchronization frame can be transmitted to the network 170 with a delay less than 120 μsec. In other words, by inserting the synchronization frame between consecutively transmitted Ethernet frames, the synchronization frame can be transmitted to the network 170 more quickly.

Incidentally, because the output timing from the MAC unit 121b can be controlled by the CPU 110, the CPU 110 monitors the TX_EN signal output from the synchronization frame generating circuit 228a and controls the MAC unit 121b to have the MAC unit 121b output no Ethernet frames during the output of a synchronization frame, so that collisions with an Ethernet frame during the output of a synchronization frame can be avoided. Output of an Ethernet frame during the output of a synchronization frame can be then avoided without the use of a FIFO memory 228d.

### Third Embodiment

In the first and second embodiments, synchronization frames are transmitted by UDP. Since UDP does not check whether or not data have arrived or resend data that fail to arrive, it is not ensured that the data reach their destination. TCP (Transmission Control Protocol) ensures that data arrive, so the arrival of synchronization frames can be assured by using TCP. In TCP, however, synchronization frames must be transmitted individually to each of the video information player devices 100, 200, so as the number of video information player devices 100, 200 increases, delays in synchronization transmission frame occur. Accordingly, use of TCP is impractical. In the third embodiment, synchronized reproduction can be performed even if a synchronization frame transmitted by use of UDP fails to reach a destination device.

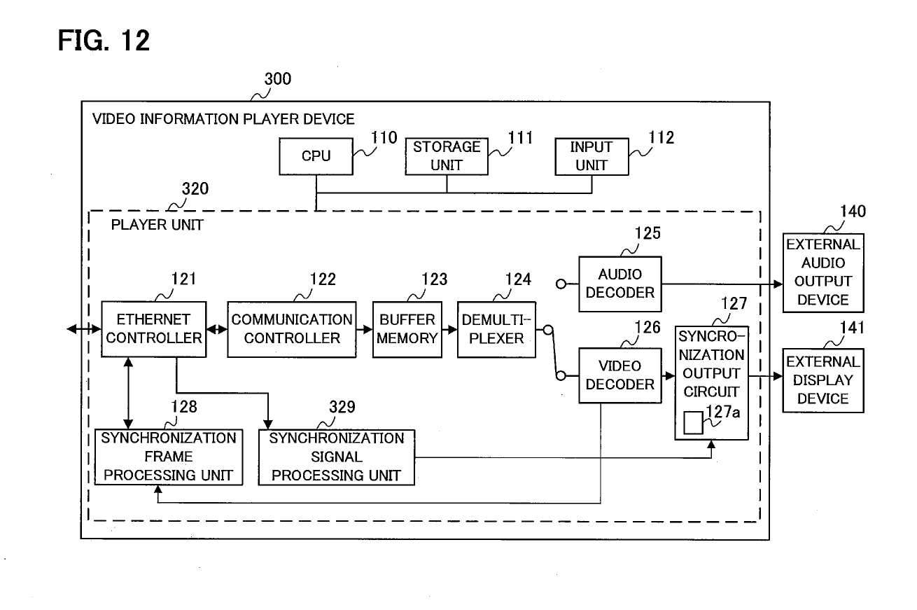

FIG. 12 is a block diagram schematically showing an example of the configuration of a video information player device 300 according to the third embodiment. The video information player device 300 has a CPU 110, a storage unit 111, an input unit 112, and a player unit 320. The video information player device 300 according to the third embodiment differs from the video information player device 100 according to the first embodiment in regard to the player unit 320.

The player unit 320 has an Ethernet controller 121, a communication controller 122, a buffer memory 123, a demultiplexer 124, an audio decoder 125, a video decoder 126, a synchronization output circuit 127, a synchronization frame processing unit 128, and a synchronization signal processing unit 329. The player unit 320 according to the third embodiment differs from the player unit 120 according to the first embodiment in regard to the synchronization signal processing unit 329.

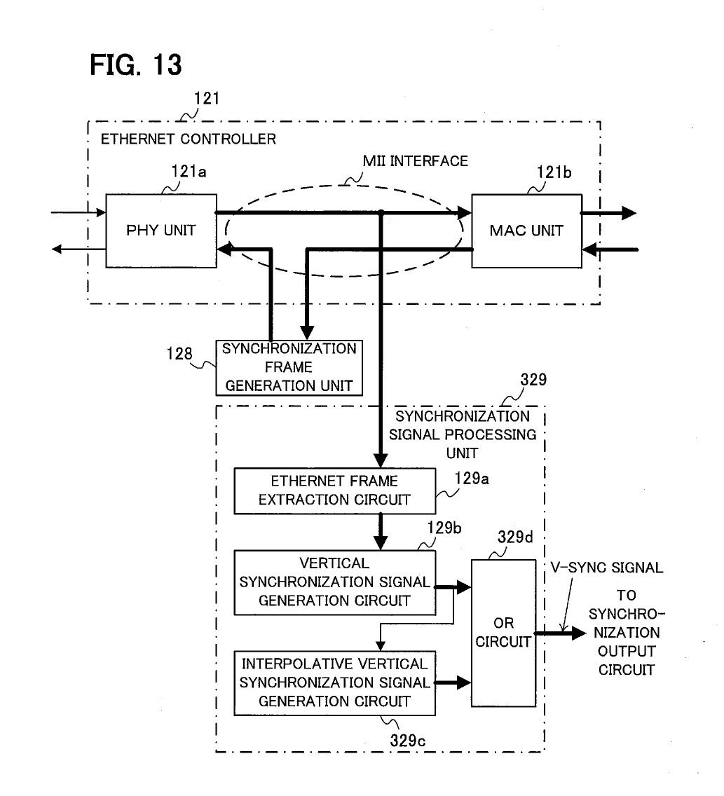

FIG. 13 is a block diagram showing the detailed configuration of the Ethernet controller 121 and synchronization signal processing unit 329. The Ethernet controller 121 is configured as in the first embodiment.

The synchronization signal processing unit 329 has an Ethernet frame extraction circuit 129a, a vertical synchronization signal generating circuit 129b, an interpolative vertical synchronization signal generating circuit 329c functioning as an interpolative vertical synchronization signal generation unit, and an OR circuit 329d functioning as OR-logic operation unit. The synchronization signal processing unit 329 according to the third embodiment differs from the synchronization signal processing unit 129 according to the first embodiment in having the interpolative vertical synchronization signal generating circuit 329c and the OR circuit 329d.

When a synchronization frame has failed to arrive for a predetermined period of time, the interpolative vertical synchronization signal generating circuit 329c outputs an interpolative V-SYNC signal. When, for example, the V-SYNC signal that should be periodically output from the vertical synchronization signal generating circuit 129b is not output for a predetermined period including a time at which the V-SYNC signal should be output, the interpolative vertical synchronization signal generating circuit 329c outputs an interpolative V-SYNC signal.

The OR circuit 329d performs an OR-logic operation on the outputs from the vertical synchronization signal generating circuit 129b and the interpolative vertical synchronization signal generating circuit 329c, and supplies the result obtained from the OR-logic operation to the synchronization output circuit 127.

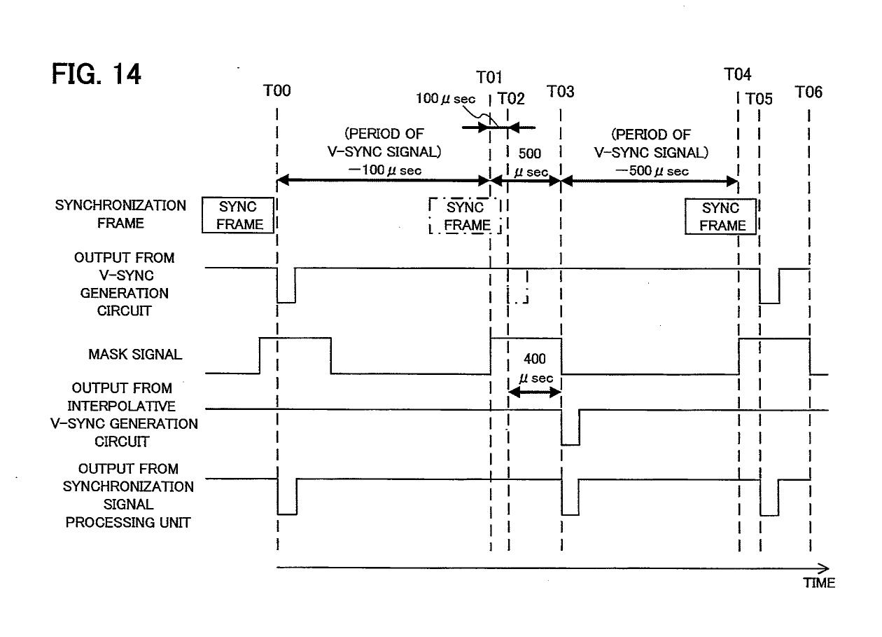

FIG. 14 is a timing diagram schematically showing the synchronization frame reception timing, the output timing of the V-SYNC signal from the vertical synchronization signal generating circuit 129b, the mask signal occurrence timing in the interpolative vertical synchronization signal generating circuit 329c, the output timing of the V-SYNC signal from the interpolative vertical synchronization signal generating circuit 329c, and the output timing of the V-SYNC signal from the synchronization signal processing unit 329.

First, when a synchronization frame is received by the Ethernet controller 121, the vertical synchronization signal generating circuit 129b outputs a V-SYNC signal at time T00.

Next, the interpolative vertical synchronization signal generating circuit 329c shifts the internally generated mask signal (shown here as a signal that is normally “Low”) to the “High” state for 500 μsec from a time T01 100 μsec before the time T02 one period of the V-SYNC signal from the time T00 at which the V-SYNC signal output from the vertical synchronization signal generating circuit 129b went from the “High” state to the “Low” state. If the frequency of the V-SYNC signal is 29.97 Hz here, then the interval from one V-SYNC signal to the next V-SYNC signal (the period of the V-SYNC signal) is approximately 33.36 msec. In the example in FIG. 14, the mask signal therefore remains in the “High” state during the time interval from the time T01 100 μsec before the time T02 33.36 msec after time T00 to a time T03 500 μsec after time T01.

Although the V-SYNC signal is normally output from the vertical synchronization signal generating circuit 129b at time T02 or in the vicinity of time T02, because the synchronization frame illustrated by the dot-dash line in FIG. 14 is not received by the Ethernet controller 121, no V-SYNC signal is output from the vertical synchronization signal generating circuit 129b in the vicinity of time T02.

When the mask signal goes to the “High” state at time T01, the interpolative vertical synchronization signal generating circuit 329c monitors the output of the V-SYNC signal from the vertical synchronization signal generating circuit 129b. When the interpolative vertical synchronization signal generating circuit 329c does not detect the V-SYNC signal from the vertical synchronization signal generating circuit 129b during the duration of the “High” state of the mask signal, the fall of the mask signal from the “High” state to the “Low” state triggers the interpolative vertical synchronization signal generating circuit 329c to output an interpolative V-SYNC signal. The OR circuit 329d performs OR logic on the outputs from the vertical synchronization signal generating circuit 129b and the interpolative vertical synchronization signal generating circuit 329c, and outputs the signal generated by the OR logic operation as a V-SYNC signal from the synchronization signal processing unit 329 to the synchronization output circuit 127. Here, a V-SYNC signal is output from the synchronization signal processing unit 329 approximately 400 μsec after the time T02 at which the V-SYNC signal would normally be output.

Next, when a synchronization frame does not arrive and the V-SYNC signal is not been output from the vertical synchronization signal generating circuit 129b, the interpolative vertical synchronization signal generating circuit 329c holds the mask signal in the “High” state for 500 μsec from a time T04 500 μsec before the time T06 following the time T03 by one period of the V-SYNC signal, the interpolative V-SYNC signal going from the “High” state to the “Low” state at the time T03. The time T04 at which the mask signal goes from the “Low” state to the “High” state is 100 μsec before the time T05 at which one period of the V-SYNC signal has elapsed since the time T02 at which the preceding V-SYNC signal should have been output.

Since the next synchronization frame is received normally in the vicinity of time T05, a V-SYNC signal is output from the vertical synchronization signal generating circuit 129b and ORed with the interpolative V-SYNC signal (“High”) by the OR circuit 329d. The result is output as the V-SYNC signal from the synchronization signal processing unit 329.

As described above, when a synchronization frame fails to arrive because of some problem, an interpolative V-SYNC signal is generated, so the impact on synchronized reproduction is minor, and synchronized reproduction can be performed continuously.

Although the duration of the “High” interval of the mask signal for detection of the V-SYNC signal is 500 sec in the third embodiment, the duration need not be fixed at 500 μsec; the duration need only be wide enough to include the time at which the V-SYNC signal goes from “Low” to “High”, considering variations in the time at which synchronization frames transmitted via the network 170 arrive.

The third embodiment described above illustrates an example in which synchronization signal processing unit 329 is used instead of the synchronization signal processing unit 129 in the player unit 120 in the first embodiment, but synchronization signal processing unit 329 may also be used instead of the synchronization signal processing unit 129 in the player unit 220 in the second embodiment.

The first to third embodiments were described above on the assumption that transmissions of content data are received from a content server 160 connected to a network 170, but this configuration is not a limitation; other embodiments may be configured so that, for example, the video information player devices 100, 200, or 300 have additional readers for reading content data from recording media such as optical discs, magnetic disks, or semiconductor memories in which the content data are recorded, and store content data read from the readers in their buffer memories 123. Alternatively, the first to third embodiments may be configured so that the video information player devices 100, 200, 300 have storage media such as HDD (hard disk drive) or SSD (solid state drive) media in which the content data are stored, read the content data from the storage media, and store the read content data in their buffer memories 123.

In the first to third embodiments described above, the video information player devices 100, 200, 300 do not include the external audio output devices 140 and external display devices 141, but these devices may be included in the configuration of the video information player devices.

The first to third embodiments described above are configured for output of video signals from the reference device among the video information player devices 100, 200, or 300 but, for example, video signals may be output only from the non-reference devices and not from the reference device. Content data identical to the content data transmitted to any of the non-reference devices may be then transmitted to the reference device.

### REFERENCE CHARACTERS

100, 200, 300: video information player device, 110: CPU, 111: storage unit, 112: input unit, 120, 220, 320: player unit, 121: Ethernet controller, 121a: PHY unit, 121b: MAC unit, 122: communication controller, 123: buffer memory, 124: demultiplexer, 125: audio decoder, 126: video decoder, 128, 228: synchronization frame processing unit, 128a, 228a: synchronization frame generating circuit, 128b: switch, 228c: first switch, 228d: FIFO memory, 228e: second switch, 129, 329: synchronization signal processing unit, 129a: Ethernet frame extraction circuit, 129b: vertical synchronization signal generating circuit, 329c: interpolative vertical synchronization signal generating circuit, 329d: OR circuit, 150: video information playing system, 160: content server, 170: network.

1. A video signal output method for synchronized output of video content signals by a plurality of video information player devices connected to a network, comprising:
a first decoding step in which one video information player device included in the plurality of video information player devices decodes content data of the content and generates a video signal and a vertical synchronization signal;
a synchronization frame generation step in which the one video information player device detects the vertical synchronization signal and, with detection of the vertical synchronization signal as a trigger, generates a synchronization frame, the synchronization frame being an Ethernet frame including information by which the synchronization frame can be recognized as having been created with the vertical synchronization signal as the trigger; and
a synchronization frame transmission step in which the one video information player device transmits the synchronization frame to the other video information player devices included in the plurality of video information player devices over the network; wherein
if another Ethernet frame is being prepared for transmission in the one video information player device when the vertical synchronization signal is detected in the synchronization frame generation step,
the synchronization frame transmission step includes
a step of storing an Ethernet frame subsequent to the another Ethernet frame,
a step of transmitting the synchronization frame after transmission of the another Ethernet frame is completed, and
a step of transmitting the stored Ethernet frame after transmission of the synchronization frame is completed.

2. The video signal output method of claim 1, further comprising a first video signal output step in which the one video information player device outputs the video signal in synchronization with the vertical synchronization signal.

3. The video signal output method of claim 1, further comprising:
a second decoding step in which the other video information player devices decode content data of the content and generate video signals from the content data;
an Ethernet frame receiving step in which the other video information player devices receive an Ethernet frame from the network;
a synchronization frame detection step in which the other video information player devices detect whether or not the received Ethernet frame is the synchronization frame;
a vertical synchronization signal generation step in which, when the other video information player devices detect the synchronization frame in the synchronization frame detection step, the other video information player devices generate vertical synchronization signals triggered by detection of the synchronization frame; and
a second video signal output step in which the other video information player devices output, in synchronization with the vertical synchronization signals generated in the vertical synchronization signal generation step, the video signals generated in the second decoding step.

4. The video signal output method of claim 3, further comprising, when the vertical synchronization signal is not generated for a predetermined period in the synchronization frame detection step:
an interpolative vertical synchronization signal generation step in which the other video information player devices generate interpolative vertical synchronization signals; and
a video signal interpolated output step in which the other video information player devices output the video signals generated in the second decoding step in synchronization with the interpolative vertical synchronization signals.

5. The video signal output method of claim 1 wherein, if the one video information player device is generating an Ethernet frame when the vertical synchronization signal is detected in the synchronization frame generation step, the synchronization frame generation step is carried out in parallel with the generation of the Ethernet frame.

6. The video signal output method of claim 1 wherein, if the one video information player device is generating a plurality of Ethernet frames consecutively when the vertical synchronization signal is detected in the synchronization frame generation step:
the synchronization frame generation step is carried out in parallel with the generation of the plurality of Ethernet frames; and
in the synchronization frame transmission step, the one video information player device transmits the synchronization frame between a pair of the Ethernet frames included in the plurality of Ethernet frames.

7. The video signal output method of claim 1, further comprising a content transmission step in which each of the plurality of video information player devices receives transmission of the content data from a content server connected to the network.

8. The video signal output method of claim 1, further comprising a content reading step in which each of the plurality of video information player devices reads the content data, the content data being recorded in a recording medium or storage medium.

9. A video information player device for outputting a video content signal in synchronization with another video information player device connected to a network, comprising:
a decoder for decoding content data of the content and generating a video signal and a vertical synchronization signal;
a synchronization frame processing unit for detecting the vertical synchronization signal and, with detection of the vertical synchronization signal as a trigger, generating a synchronization frame, the synchronization frame being an Ethernet frame including information by which the synchronization frame can be recognized as having been created with the vertical synchronization signal as the trigger;
an Ethernet controller for transmitting the synchronization frame to the another video information player device over the network; and
a synchronized output unit for outputting the video signal in synchronization with the vertical synchronization signal; wherein
if the Ethernet controller is generating an Ethernet frame when the vertical synchronization signal is detected, the synchronization frame processing unit generates the synchronization frame in parallel with the generation of the Ethernet frame.

10. The video information player device of claim 9, wherein:
the Ethernet controller includes
a MAC unit for generating the Ethernet frame, and
a PHY unit for transmitting the Ethernet frame generated by the MAC unit and the synchronization frame generated by the synchronization frame processing unit to the network; and
the synchronization frame processing unit includes
a synchronization frame generating unit for detecting the vertical synchronization signal and generating the synchronization frame triggered by detection of the vertical synchronization signal,
a storage unit for storing an Ethernet frame,
a first switching unit for receiving the Ethernet frame generated by the MAC unit and switching output destinations of the Ethernet frame, and
a second switching unit for switching input sources of the Ethernet frame output to the PHY unit; and wherein
if the Ethernet frame received from the MAC unit is being output to the second switching unit when the synchronization frame generating unit detects the vertical synchronization signal, after completion of the output of the Ethernet frame to the second switching unit, the first switching unit switches the output destination of the Ethernet frame subsequent to the Ethernet frame the output of which has been completed to the storage unit, and
if the second switching unit is receiving input of an Ethernet frame from the first switching unit when the synchronization frame generating unit generates the synchronization frame, after completion of the input of the Ethernet frame input from the first switching unit, the second switching unit switches the input source of the Ethernet frame output to the PHY unit to the synchronization frame generating unit and accepts input of the synchronization frame, and after completion of the input of the synchronization frame, switches the input source of the Ethernet frame output to the PHY unit to the storage unit and accepts input of the Ethernet frames stored in the storage unit.

11. The video information player device of claim 9, wherein:
if the Ethernet controller is generating a plurality of Ethernet frames consecutively when the vertical synchronization signal is detected, the synchronization frame processing unit generates the synchronization frame in parallel with the generation of the Ethernet frames; and
the Ethernet controller transmits the synchronization frame between a pair of the Ethernet frames included in the plurality of Ethernet frames.

12. A video information player device for outputting a video content signal in synchronization with another video information player device connected to a network, comprising:
a decoder for decoding content data of the content and generating a video signal;
an Ethernet controller for receiving an Ethernet frame through the network;
a synchronization signal processing unit for detecting whether or not the Ethernet frame is a synchronization frame, the synchronization frame being an Ethernet frame including information by which the synchronization frame can be recognized as having been created with a vertical synchronization signal as a trigger, and generating a vertical synchronization signal; and
a synchronized output unit for outputting the video signal in synchronization with the vertical synchronization signal.

13. The video information player device of claim 12, wherein the synchronization signal processing unit further comprises:
a vertical synchronization signal generating unit for detecting whether or not the Ethernet frame is the synchronization frame, and generating the vertical synchronization signal with detection of the synchronization frame as a trigger; and
an interpolative vertical synchronization signal generating unit for generating an interpolative vertical synchronization signal when the synchronization signal generating unit does not generate the vertical synchronization signal for a predetermined period; and wherein
the synchronized output unit outputs the video signal in synchronization with both the vertical synchronization signal and the interpolative vertical synchronization signal.

14. The video information player device of claim 9, wherein the content data are received from a content server connected to the network, via the Ethernet controller.

15. The video information player device of claim 9, further comprising a reading unit for reading the content data from a recording medium in which the content data are recorded.

16. The video information player device of claim 9, further comprising a storage medium in which the content data are stored.

17. A video information player device for outputting a video content signal in synchronization with another video information player device connected to a network, comprising:
a decoder for decoding content data of the content and generating a video signal and a vertical synchronization signal;
a synchronization frame processing unit for detecting the vertical synchronization signal and, with detection of the vertical synchronization signal as a trigger, generating a synchronization frame, the synchronization frame being an Ethernet frame including information by which the synchronization frame can be recognized as having been created with the vertical synchronization signal as the trigger;
an Ethernet controller for transmitting the synchronization frame over the network to the another video information player device included in the plurality of video information player devices and for receiving an Ethernet frame from the network;
a synchronization signal processing unit for detecting whether or not the Ethernet frame received by the Ethernet controller is the synchronization frame, and generating the vertical synchronization signal;
a synchronized output unit for outputting the video signal in synchronization with the vertical synchronization signal generated by the decoder and the synchronization signal processing unit;
a storage unit for storing synchronization reference setting information indicating whether or not the device itself is a synchronization reference device; and
a control unit for, when the device itself is the synchronization reference device, controlling the synchronization frame processing unit, the Ethernet controller, and the synchronized output unit to carry out processing for generating and transmitting the synchronization frame and for outputting the video signal output in synchronization with the vertical synchronization signal generated by the decoder, and when the device itself is not the synchronization reference device, controlling the synchronization signal processing unit and the synchronized output unit to carry out processing for outputting the video signal in synchronization with the vertical synchronization signal generated by the synchronization signal processing unit.
